(19) United States
(12) Patent Application Publication
(10) Pub. No.: US 2022/0227355 A1
(43) Pub. Date: Jul. 21, 2022

(54) METHOD FOR OPERATING A MOTOR VEHICLE, MOTOR VEHICLE, AND COMPUTER PROGRAM PRODUCT

(71) Applicant: AUDI AG, Ingolstadt (DE)

(72) Inventors: Reimund LIMBACHER, lngolstadt (DE); Philipp KRETSCHMANN, Manching (DE)

(73) Assignee: AUDI AG, Ingolstadt (DE)

(21) Appl. No.: 17/613,314

(22) PCT Filed: May 20, 2020
(86) PCT No.: PCT/EP2020/064110

§ 371 Date: Nov. 22, 2021

(30) Foreign Application Priority Data
May 22, 2019 (DE) 10 2019 207 485.5

(51) Int. Cl. B60W 30/06; B60W 50/14; B60W 60/00; G06N 20/00

(52) U.S. Cl. CPC B60W 30/06; B60W 50/14; B60W 2050/146; G06N 20/00; B60W 2050/143; B60W 60/005

(57) ABSTRACT

A motor vehicle has a parking assistance system with an output device which outputs acoustic and/or visual information as an aid when parking in an activated state and which does not output said information in a deactivated state. In a learning mode, the parking assistance system learns exceptions in which either an automatic changeover is carried out between the activated state and the deactivated state as an exception or an automatic changeover is not carried out between the activated state and the deactivated state as an exception, and/or a manual changeover is detected between the activated state and the deactivated state by the parking assistance system. When a specified changeover characteristic for a manual changeover between the activated state and the deactivated state is detected, a recommendation is output for a changeover between an automatic mode and a manual mode of the parking assistance system, wherein an automatic changeover is carried out between the activated state and the deactivated state in the automatic mode, and the automatic changeover is not carried out in the manual mode.

### TECHNICAL FIELD

The present disclosure relates to a method for operating a motor vehicle, to a motor vehicle, and to a computer program product.

### BACKGROUND

A large number of motor vehicles of the current generation is equipped with a driver assistance system that supports a driver when parking. Such a driver assistance system is also called a parking assistance system or parking assistant. In addition, various manufacturer-specific terms such as park distance control (PDC) are also used for such a driver assistance system. Most of the embodiment variants of a corresponding driver assistance system have in common that they have a surroundings sensor system by means of which distances to objects in the immediate surroundings of the motor vehicle are detected and that information on these distances is output to the driver of the motor vehicle via an output unit. In this case, the information is output to the driver as acoustic information or as visual information, and accordingly the output unit is then designed, for example, as a loudspeaker or as a display screen.

Furthermore, the assistance function implemented by means of the driver assistance system or the entire driver assistance system can in most cases be activated and deactivated via a simple control element, for example a switch or button, so that the driver can decide for himself when to use the driver assistance system or the assistance function and when not.

Some design variants also offer the possibility of using an automatic function that automatically activates and deactivates the output unit when a specific condition is met, for example when the distance to the closest object falls below a minimum value.

### BRIEF DESCRIPTION OF DRAWINGS/FIGURES

FIG. 1 illustrates a block diagram of a motor vehicle with a parking assistance system.

### DETAILED DESCRIPTION

The object of the present embodiment of the invention is to specify an advantageous method for operating a motor vehicle, an advantageous motor vehicle, and an advantageous computer program product.

The method according to the embodiment of the invention is used to operate a motor vehicle and, in particular, to implement a driver assistance function by means of which a driver is supported when parking the motor vehicle. The motor vehicle according to the embodiment of the invention in turn has a driver assistance system and is configured to carry out the method according to the embodiment of the invention in at least one operating mode. For this purpose, the motor vehicle typically has a data processing unit with an executable program which automatically executes the method according to the embodiment of the invention after it is started. The start of the program is preferably carried out automatically when the motor vehicle is started and the program is preferably implemented using software that is provided, for example, via a computer program product according to the embodiment of the invention and that is typically installed on the data processing unit so that the program can subsequently be executed on the data processing unit.

As already explained above, the motor vehicle according to the embodiment of the invention now has a driver assistance system which assists a driver when parking the motor vehicle. Accordingly, the driver assistance system is designed as a parking assistance system and the driver assistance function or assistance function implemented therewith is designed as a parking assistance function, or parking assistance for short. In this case, the parking assistance system has an output device which outputs acoustic and/or visual information as an aid when parking in an activated state and which does not output said information in a deactivated state.

The acoustic information is, for example, beep tones and in this case the output device then typically has at least one loudspeaker. As an alternative or in addition to such acoustic information, visual information is output via the output device in the activated state, and, for this purpose, the output device then has, for example, an LED strip. Another embodiment variant is preferred in which the output device for outputting visual information has a display screen or a display which is arranged, for example, in the region of the so-called center console of the motor vehicle or in the region of the so-called speedometer unit. Alternatively, such a display is designed, for example, as a so-called head-up display.

The parking assistance system preferably supports the driver only by outputting the acoustic and/or visual information in the activated state when parking and not by intervening in the vehicle control. The parking assistance system is therefore in particular not designed for automatic/autonomous or partially automatic/partially autonomous vehicle guidance when parking.

If the method according to the embodiment of the invention is now carried out, in a learning mode of the parking assistance system, exceptions are learned in which either an automatic changeover is carried out between the activated state and the deactivated state as an exception or an automatic changeover is not carried out between the activated state and the deactivated state as an exception.

As an alternative or in addition to this, a manual changeover between the activated state and the deactivated state is detected by the parking assistance system when the method according to the embodiment of the invention is carried out and recommendations for the use, i.e. in particular further use, of the parking assistance system are output on the basis of a detected manual changeover. When a specified changeover characteristic for a manual changeover between the activated state and the deactivated state is detected, a recommendation is output for a changeover between an automatic mode and a manual mode of the parking assistance system. The automatic mode and the manual mode then represent two operating modes or modes of operation of the parking assistance system, wherein a changeover is carried out automatically between the activated state and the deactivated state of the output device in the automatic mode, and wherein an automatic changeover is not carried out in the manual mode.

In the automatic mode, an additional auxiliary function is thus typically implemented, namely an automatic changeover system by which the output device is controlled in the automatic mode. A control is preferably carried out in such a way that a changeover from the activated state to the deactivated state or a changeover from the deactivated state to the activated state is only carried out automatically under a specified condition.

The specified condition is then preferably a threshold value for the distance to the closest object in the surroundings of the motor vehicle, for example to another motor vehicle, to a wall, to a person, or to any other object. Accordingly, the motor vehicle according to the embodiment of the invention preferably has a surroundings sensor system by means of which the surroundings or the environment of the motor vehicle are/is monitored in at least one operating mode and typically by default during operation of the motor vehicle and by means of which the distances to objects in the immediate surroundings of the motor vehicle are expediently detected by measurement. This information is further processed or evaluated in the parking assistance system and, if the distance to an object in the surroundings does not reach the specified threshold value, the output device is automatically switched from the deactivated state to the activated state, provided the parking assistance system is in automatic mode. If the threshold value is exceeded again, typically an automatic changeover is carried out from the activated state to the deactivated state. The threshold value, namely the first threshold value, is approximately 100 cm in this case, for example.

A second threshold value or minimum distance is also preferably specified, for example about 30 cm, and if the second minimum distance is not reached, an automatic changeover is always carried out to the activated state of the output device, preferably independently of the current operating mode of the parking assistance system and/or independently of possible exceptions.

Depending on the embodiment variant, such an automatic changeover system is preferably designed independently of this in such a way that the specified threshold value is only taken into account when no reverse gear is engaged in the vehicle. If, on the other hand, a reverse gear is engaged, independently of whether a manual gearbox or an automatic gearbox is installed in the motor vehicle, a changeover is preferably automatically carried out from the deactivated state to activated state in each case independently of the specified threshold value and more preferably independently of the current operating mode of the parking assistance system and/or independently of possible exceptions.

Such an automatic changeover system supports the driver in using the parking assistance system. However, there are situations in which the automatic changeover system carries out a changeover, even if this is not helpful for the driver. This is the case, for example, when the motor vehicle approaches another motor vehicle in front of the motor vehicle at a traffic light and comes to a stop behind it. Even in traffic jam situations, a corresponding automatic changeover is usually not helpful and can even have a disruptive effect for the driver.

For this reason, the motor vehicle according to the embodiment of the invention is preferably configured in such a way that the driver can deactivate or switch off this automatic changeover system by deselecting the automatic mode and selecting the manual mode. For this purpose, the motor vehicle typically has an on-board computer via which the driver can change the mode, i.e. via which the mode can be changed.

In addition, there is preferably the possibility for the driver to switch the output device from the activated state to the deactivated state or from the deactivated state to the activated state, for example via a switch or button on the center console of the motor vehicle or via a steering wheel button, wherein the driver preferably only has to tap the button or the steering wheel button for a changeover. In this case, however, preferably a changeover is only carried out between the activated state and the deactivated state of the output device and a changeover is not carried out between the automatic mode and the manual mode and accordingly an automatic changeover is carried out again between the activated state and the deactivated state of the output device as soon as the specified conditions for an automatic changeover are met.

In order to additionally support the driver in using the parking assistance system, in the embodiment of the method according to the embodiment of the invention, the manual changeover between the activated state and the deactivated state of the output device is now detected by the driver and, when a specified changeover characteristic is recognized, a recommendation is output to the driver in acoustic and/or visual form to carry out a changeover between automatic mode and manual mode.

In this case, only that manual changeover between the activated state and the deactivated state of the output device is preferably detected and/or processed and/or evaluated that takes place within a specified first time interval T1 after an automatic changeover. As the first time interval T1, an interval of approximately 10 s and in particular of approximately 5 s is preferably specified. In such cases, the driver reacts very quickly to an automatic changeover, whereby he quasi reverses the automatic changeover by a manual changeover. It can therefore be assumed in these cases in particular that the automatic changeover was carried out in an undesired manner.

Furthermore, according to one embodiment variant, the specified changeover characteristic is detected or recognized if a manual changeover from the activated state to the deactivated state is carried out several times within a specified second time interval T2, typically more than twice and in particular at least five times, or if within the specified second time interval T2 a changeover from the deactivated state to the activated state is carried out several times, typically more than twice and in particular at least five times.

As an alternative or in addition to the above-described detection of the manual changeover and the output of recommendations, when the method according to the embodiment of the invention is executed, in a learning mode of the parking assistance system, exceptions are learned in which either an automatic changeover is carried out between the activated state and the deactivated state as an exception or an automatic changeover is not carried out between the activated state and the deactivated state as an exception.

Both approaches are viewed independently of one another as independently inventive and therefore divisional applications for these approaches are expressly reserved. In both approaches, the effectiveness and user-friendliness are increased based on a parking assistance system according to the prior art, so that both solve the same technical problem. Both approaches can also be combined with one another.

In the learning mode, a kind of adaptive automatic changeover system is implemented, wherein the learning mode replaces the automatic mode described above, depending on the embodiment variant. Alternatively, the learning mode replaces the aforementioned manual mode or the learning mode supplements the automatic mode and the manual mode as an additional operating mode, so that, in this case, the driver can choose between three different operating modes. An embodiment variant is also advantageous in which the learning mode replaces both the automatic mode and the manual mode and is therefore the only operating mode available.

In the learning mode of the parking assistance system, the parking assistance system expediently detects a manual changeover between the activated state and the deactivated state. In this case, the exceptions are learned on the basis of the manual changeover detected. In this case, only that manual changeover between the activated state and the deactivated state of the output device is preferably detected and/or processed and/or evaluated that takes place within a specified first time interval T1 after an automatic changeover. As the first time interval T1, an interval of approximately 10 s and in particular of approximately 5 s is preferably specified.

Independently of this, each exception is typically defined by a data record that is stored in a memory of the parking assistance system, in particular in a memory of a data processing unit of the parking assistance system, which was therefore stored in the memory when the corresponding exception was learned.

It is also advantageous if the motor vehicle has a system for determining the position of the motor vehicle, for example a GPS system. This system is part of a navigation system of the motor vehicle, for example. In this case, in the learning mode of the parking assistance system, the parking assistance system further preferably detects or determines location data on a location, at which a manual changeover between the activated state and the deactivated state is carried out. Such a location is then preferably learned as an exception in the learning mode of the parking assistance system, at least if this location is approached repeatedly and if a manual changeover between the activated state and the deactivated state is carried out repeatedly at this location. The system thus recognizes or learns that an automatic changeover is undesirable at a specific location if the driver repeatedly carries out a manual changeover at this location.

An embodiment variant is favorable in this case in which, in the learning mode of the parking assistance system, by default, an automatic changeover is not carried out from the deactivated state to the activated state, in which, in the learning mode, exceptions are learned, in which an automatic changeover is carried out from the deactivated state to the activated state as an exception, wherein locations are learned as exceptions that are repeatedly approached and at which a manual changeover is carried out repeatedly from the deactivated state to the activated state. At this location, based on the learned exception, an automatic changeover is carried out from the deactivated state to the activated state when the motor vehicle is again at this location.

In this case, too, an automatic changeover is preferably only carried out when the motor vehicle approaches an object in the immediate surroundings at a location learned as an exception to a specified minimum distance, in particular the aforementioned first threshold value. In this case, the specified minimum distance represents an additional condition. For example, a value of around 100 cm is specified as the minimum distance.

If a location is now learned as an exception, information on this location is preferably stored in the aforementioned memory. This information contains, for example, a set of GPS coordinates or is formed by a corresponding set of GPS coordinates. Since a learned location is typically not a position but rather a spatial range around a position, a radius is also preferably specified which defines how far a location extends around a position, which is defined, for example, by GPS coordinates. This radius is preferably less than approximately 10 m and in particular less than approximately 5 m. The spatial range is thus preferably about as large as a typical parking lot or parking space for a motor vehicle.

According to an advantageous development, a location that is repeatedly approached and at which a manual changeover is carried out repeatedly from the deactivated state to the activated state is initially only recognized as a potential exception and an input request is then output by which the driver is requested to select whether or not the potential exception should be learned as an exception. The location is only actually saved as an exception, and thus as an out exception, when the driver makes the selection that the location is to be learned as an exception.

In accordance with a further embodiment variant, such an input request is carried out when a location is approached for the first time. Alternatively, such an input request is carried out when first approached only at specific locations which are identified as special cases, for example, on the basis of information from the navigation system of the motor vehicle. For example, it is useful to treat locations as special cases where there are car washes or parking garages, for example.

In addition, it is advantageous if the driver has the option of directly specifying locations where the parking assistance system should make an exception. In this case, the driver manually specifies exceptions, for example, via a menu of the on-board computer or via the navigation system. As an alternative or in addition thereto, the driver is given the opportunity to delete exceptions again, i.e. to delete locations again that are stored as exceptions.

It is also useful to allow the creation of multiple profiles for multiple drivers, each profile then including its own list of exceptions. Such a list can then preferably be transferred from one profile to another profile and/or exported to another motor vehicle or to a server.

It is also considered to be advantageous if exceptions are learned by means of a so-called geo-learning method/geo-fencing method, for example by means of a so-called DB scan method.

It is also considered expedient if, when learning exceptions, only a manual changeover described above is detected and otherwise no further activities by the driver, in particular no further inputs are detected. In addition, only location data are preferably stored and learned in this way, i.e. in particular, only one set of location coordinates per exception.

Further advantages, features and details of the embodiments of the invention will become apparent from the claims, the following description of preferred embodiments and from the schematic drawing. In the drawing:

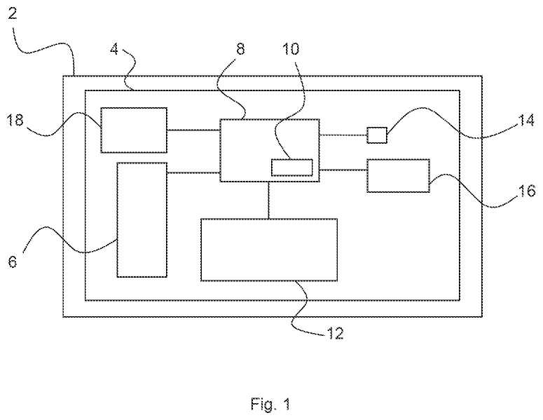

FIG. 1 is a block diagram of a motor vehicle with a parking assistance system.

A motor vehicle 2 described below by way of example is shown schematically in FIG. 1 by a block diagram and has a parking assistance system 4. Part of the parking assistance system 4 are a surroundings sensor system 6, a data processing unit 8 having a memory 10, an output device 12, a button 14, an operating unit 16, and a navigation system 18.

The output device 12 is designed to output acoustic and visual information to a driver as an aid when parking in an activated state and not to output said information in a deactivated state. For this purpose, the output device 12 has a display screen on which, in the activated state, images from a camera that is part of the sensor system 6 are reproduced. In addition, the output device 12 has a loudspeaker via which, in the activated state of the output device 12, acoustic information is output in the form of beep tones.

Furthermore, in the embodiment, the parking assistance system 4 is configured in such a way that the parking assistance system 4 automatically carries out a changeover between the activated state and the deactivated state of the output device 12 when specified conditions are met. In addition, the parking assistance system 4 is configured for operating in a learning mode in which exceptions are learned, in which either an automatic changeover is carried out between the activated state and the deactivated state as an exception or an automatic changeover is not carried out as an exception.

According to a first embodiment variant, by default, no automatic changeover is carried out from the deactivated state to the activated state, and exceptions are learned in which an automatic changeover occurs as an exception. For this purpose, a manual changeover from the deactivated state to the activated state is detected by the parking assistance system 4, i.e. a changeover that is induced by the driver. A manual changeover takes place when the driver taps the button 14, wherein a changeover is carried out to the activated state when the output device 12 is in the deactivated state, and a changeover is carried out to the deactivated state when the output device 12 is in the activated state. This manual changeover is detected by the parking assistance system 4 in the learning mode.

In this case, only that manual changeover between the activated state and the deactivated state of the output device 12 is preferably detected and/or processed and/or evaluated that takes place within a specified first time interval T1 after an automatic changeover. As the first time interval T1, an interval of approximately 10 s and in particular of approximately 5 s is preferably specified.

If there is now a manual changeover to the activated state, the parking assistance system 4 uses the navigation system 18 to determine the location at which the manual changeover was carried out, and this location is stored in the memory 10 of the data processing unit 8. For this purpose, a set of GPS coordinates is stored in memory 10, for example. If at a later point in time the motor vehicle 2 again reaches a location stored in the memory 10 and if a manual changeover to the activated state is carried out again at this location, this location is learned as an exception by the parking assistance system 4 and is stored in the memory 10. Alternatively, the driver is first requested by the parking assistance system 4 to decide whether the location should be learned as an exception or not, and only if the driver decides in favor of the former is the location stored as an exception in the memory 10 and thus learned.

If a location learned as an exception is then approached again with the motor vehicle 2, the parking assistance system 4 exceptionally automatically carries out a changeover from the deactivated state of the output device 12 to the activated state as soon as a specified first minimum distance of, for example, 100 cm to an object in the surroundings of the motor vehicle 2 is undershot. The surroundings or the environment of the motor vehicle 2 are/is permanently monitored by means of the surroundings sensor system 6, at least in the learning mode, and distances to objects in the surroundings or in the environment of the motor vehicle 2 are determined.

A second minimum distance is also preferably specified, for example 30 cm, and if the second minimum distance is not reached, an automatic changeover is always carried out to the activated state of the output device 12, independently of whether the location where the motor vehicle 2 is currently located is stored as an exception in the memory 10 or not.

According to an alternative embodiment variant, an automatic changeover is carried out from the deactivated state to the activated state as standard in the learning mode as soon as the specified first minimum distance of, for example, 100 cm is undershot. In this case, the parking assistance system 4 then learns exceptions in which no automatic changeover is carried out as an exception. If a specific location is approached in this case repeatedly and a manual changeover is carried out from the activated state to the deactivated state at this location repeatedly after an automatic changeover from the deactivated state to the activated state has been carried out by the parking assistance system 4, this location is learned as an exception and stored in the memory 10. According to a variation of this embodiment variant, the driver is in turn first requested to decide whether or not this location should be learned as an exception.

Furthermore, the parking assistance system 4 is configured in the embodiment to manually process the exceptions stored in the memory 10. For this purpose, for example, a menu can be called up via the operating unit 16 and a list of locations that are stored as exceptions can be displayed via the output device 12. The operating unit 16 can then be used to delete and/or add locations as exceptions, for example by selecting a location using the navigation system 18.

Independently of this, the parking assistance system 4 is configured for more than one operating mode, depending on the embodiment variant, and in this case the driver is then able to select an operating mode via the operating unit 16 or to switch between the operating modes. The learning mode is one of the available operating modes. Another operating mode is, for example, a manual mode in which basically no automatic changeover is carried out between the activated state and the deactivated state of the output device 12. As an alternative or in addition thereto, an automatic mode can be selected as the operating mode, in which, without exception, an automatic changeover is carried out between the activated and the deactivated state if the specified first minimum distance is undershot.

Corresponding to a further embodiment variant, the parking assistance system 4 is configured for the aforementioned automatic mode and the aforementioned manual mode, but not necessarily for the learning mode. If the parking assistance system is then operated with one of these two operating modes, a manual changeover between the activated state and the deactivated state is detected.

In this case, in turn only that manual changeover between the activated state and the deactivated state of the output device 12 is preferably detected and/or processed and/or evaluated that takes place within a specified first time interval T1 after an automatic changeover. As the first time interval T1, an interval of approximately 10 s and in particular of approximately 5 s is preferably specified.

If more than two manual changeover operations are then detected within a specified second time span or a specified second time interval T, the parking assistance system 4 outputs a recommendation to carry out a changeover between the automatic mode and the manual mode.

If the parking assistance system 4 is, for example, in automatic mode and the driver manually switches the output device 12 to the deactivated state more than twice within the second time interval T2 by pressing the button 14 after an automatic changeover is carried out to the activated state, a recommendation is output to carry out a changeover to the manual mode. Conversely, a recommendation is output to switch to the automatic mode if a manual changeover is carried out to the activated state more than twice within the time period T2. However, when counting the manual changeover operations, as already explained above, only that manual changeover is preferably taken into account and thus detected that is carried out within the first time interval T1 after an automatic changeover.

For example, an interval of 10 minutes or 20 minutes is specified as the time interval and, depending on the embodiment variant, the recommendation is output, for example, by voice output over the loudspeaker and/or by a message on the display screen.

In such an embodiment variant with the output of a recommendation, no location dependency is provided, so that it does not matter at which location the motor vehicle 2 is located when a manual changeover is carried out between the activated state and the deactivated state. Only the number of manual changeover operations, the specified second time interval T2, and in most cases also the specified first time interval T1 are preferably relevant to determine when a recommendation is output and when it is not output.

### LIST OF REFERENCE SIGNS

2 Motor vehicle
4 Parking assistance system
6 Surroundings sensors
8 Data processing unit
10 Memory
12 Output device
14 Button
16 Control unit
18 Navigation system

1. (canceled)

2. (canceled)

3. (canceled)

4. (canceled)

5. (canceled)

6. (canceled)

7. (canceled)

8. (canceled)

9. (canceled)

10. (canceled)

11. A method for operating a motor vehicle, wherein the motor vehicle has a parking assistance system with an activated state and a deactivated state, the parking assistance system including an output device, wherein, when parking in an activated state, the output device outputs acoustic and/or visual information as an aid and the information is not output, by the output device, in a deactivated state, the method comprising:
learning, in a learning mode of the parking assistance system, exceptions, wherein the exceptions include either an automatic changeover is carried out between the activated state and the deactivated state, or an automatic changeover is not carried out between the activated state and the deactivated state;
detecting, by the parking assistance system, a manual changeover between the activated state and the deactivated state; and
when a specified changeover characteristic for the manual changeover between the activated state and the deactivated state is detected, outputting a recommendation for a changeover between an automatic mode and a manual mode of the parking assistance system, wherein an automatic changeover is carried out between the activated state and the deactivated state in the automatic mode, and the automatic changeover is not carried out in the manual mode.

12. A method according to claim 11, further comprising:
dispensing with automatic or semi-automatic vehicle guidance when parking; and
supporting a driver with only outputting the acoustic and/or visual information in the activated state when parking.

13. A method according to claim 11, further comprising:
detecting, in the learning mode of the parking assistance system, a manual changeover between the activated state and the deactivated state; and
learning the exceptions based on a detected manual changeover.

14. A method according to claim 11, wherein detecting the manual changeover between the activated state and the deactivated state is carried out within a specified first time interval T1 after an automatic changeover between the activated state and the deactivated state.

15. A method according to claim 13, further comprising:
detecting, in the learning mode of the parking assistance system, location data on a location at which a manual changeover between the activated state and the deactivated state is carried out.

16. A method according to claim 15, wherein learning the exceptions includes learning a location, wherein the location is approached repeatedly and at which a manual changeover between the activated state and the deactivated state is carried out repeatedly.

17. A method according to claim 16, wherein, in the learning mode of the parking assistance system:
no automatic changeover is carried out from the deactivated state to the activated state by default,
the exceptions are learned in which an automatic changeover is carried out from the deactivated state to the activated state as an exception,
the locations are learned as exceptions that are repeatedly approached and at which a manual changeover is carried out repeatedly from the deactivated state to the activated state, and
an automatic changeover is carried out from the deactivated state to the activated state when the motor vehicle approaches an object in the surroundings at a specified minimum distance at a location learned as an exception.

18. A method according to claim 15, further comprising:
outputting, in the learning mode, an input request if a manual changeover between the activated state and the deactivated state is detected at a location, and the location is specified as an exception with a specified input.

19. A motor vehicle comprising:
a parking assistance system with an activated and a deactivated state;
an output device which outputs acoustic and/or visual information as an aid when parking in an activated state; and
a processing unit configured to:
learn, in a learning mode of the parking assistance system, exceptions, wherein the exceptions include either an automatic changeover is carried out between the activated state and the deactivated state, or an automatic changeover is not carried out between the activated state and the deactivated state;
detect, by the parking assistance system, a manual changeover between the activated state and the deactivated state; and
when a specified changeover characteristic for the manual changeover between the activated state and the deactivated state is detected, output a recommendation for a changeover between an automatic mode and a manual mode of the parking assistance system, wherein an automatic changeover is carried out between the activated state and the deactivated state in the automatic mode, and the automatic changeover is not carried out in the manual mode.

20. A computer program product in a motor vehicle, wherein the motor vehicle has a parking assistance system with an activated state and a deactivated state, the parking assistance system including an output device, wherein, when parking in an activated state, the output device outputs acoustic and/or visual information as an aid and the information is not output, by the output device, in a deactivated state, the computer program product comprising instructions which, when executed by a computer, cause the computer to perform operations comprising:
learning, in a learning mode of the parking assistance system, exceptions, wherein the exceptions include either an automatic changeover is carried out between the activated state and the deactivated state, or an automatic changeover is not carried out between the activated state and the deactivated state;
detecting, by the parking assistance system, a manual changeover between the activated state and the deactivated state; and
when a specified changeover characteristic for the manual changeover between the activated state and the deactivated state is detected, outputting a recommendation for a changeover between an automatic mode and a manual mode of the parking assistance system, wherein an automatic changeover is carried out between the activated state and the deactivated state in the automatic mode, and the automatic changeover is not carried out in the manual mode.
